(19) United States
(12) Patent Application Publication
(10) Pub. No.: US 2005/0265660 A1
(43) Pub. Date: Dec. 1, 2005

(54) Photonic coupling device

(75) Inventor: Robert O. Miller, Rochester, MI (US)

Correspondence Address: ENERGY CONVERSION DEVICES, INC., 2956 WATERVIEW DRIVE, ROCHESTER HILLS, MI, 48309, US

(73) Assignee: Energy Conversion Devices, Inc.

(21) Appl. No.: 11/124,736

(22) Filed: May 9, 2005

Related U.S. Application Data
(63) Continuation-in-part of application No. 10/855,482, filed on May 27, 2004.

(51) Int. Cl. G02B 6/26; G02B 6/42

(52) U.S. Cl. 385/43; 385/39; 385/42; 385/129

(57) ABSTRACT

A photonic coupling device for the efficient transfer of an optical signal to or from a photonic crystal. The element receives an optical signal from a transmitting element connected to its input end and efficiently transmits that signal to a receiving element connected to its output end. Efficient transfer is accomplished by designing the coupling element to provide a gradual transition from the propagation environment of the transmitting element to the propagation environment of the receiving element. In one embodiment, the photonic coupling device is partially embedded in a photonic crystal receiving element. In a preferred embodiment, the photonic crystal includes a defect and the optical signal propagating in the coupling device is a frequency that corresponds to a frequency associated with the photonic bandgap state of the defect. The photonic coupling device may include a tapered shape that promotes a gradual delocalization of an optical signal propagating therein into a photonic crystal receiving element, whereupon the optical signal is influenced by the photonic crystal and is preferably localized in a photonic crystal defect. In other embodiments, the photonic coupling device includes a series of holes tapered in size that act to gradually transform the environment of a propagating optical signal from that of a waveguide or photonic wire to that of a linear defect in a hole photonic crystal. Still other embodiments include photonic coupling devices having photonic grooves and tapered variations thereof, optionally in combination with a hole taper.

### CROSS-REFERENCE TO RELATED APPLICATIONS

This application is a continuation in part of U.S. patent application Ser. No. 10/855,482, entitled “Optical Coupling Device” and filed on May 27, 2004, the disclosure of which is hereby incorporated by reference herein.

### FIELD OF INVENTION

This invention relates to coupling elements for the transmission of light between components of an integrated optical system. More specifically, this invention relates to coupling elements that provide efficient transfer of guided modes between optical elements and photonic crystals. Most specifically, this invention relates to quasi-adiabatic coupling elements for interfacing photonic wires and photonic crystals that provide for nearly lossless transfer of mode intensity between elements.

### BACKGROUND OF THE INVENTION

Recent advances in optical components for controlling the properties of optical signals include photonic crystals. A photonic crystal possesses a photonic band gap that defines a range of electromagnetic frequencies that are unable to propagate in the crystal. Photonic crystals include a periodic arrangement of one dielectric material within a surrounding dielectric material. The precise details and dimensionality of the periodic pattern of the one dielectric material within a surrounding dielectric material and the refractive index contrast between the periodically arranged regions and the surrounding material dictate the characteristics of the photonic bandgap of a photonic crystal. Important material design considerations include the size, spacing and arrangement of macroscopic dielectric media within a volume of surrounding material as well as the refractive indices of the dielectric and surrounding materials. The periodicity of the macroscopic dielectric media can extend in one, two or three dimensions. These considerations influence the magnitude of the photonic band gap, the frequency range of light or other electromagnetic energy (e.g. infrared, microwave etc.) that falls within the photonic band gap and whether the photonic band gap is full (in which case the photonic band gap effect is manifested regardless of the direction of propagation of the incident light) or partial (in which case the photonic band gap effect is manifested for some, but not all, directions of propagation). Other practical considerations are also relevant such as manufacturability, cost, ability to fabricate a periodic array of rods etc.

Light having an energy within the photonic band gap and propagating in a direction defined by the photonic band gap is blocked and unable to propagate in a photonic crystal. When external light having an energy and direction of propagation within the photonic band gap is made incident to a photonic crystal, it is unable to propagate through the crystal. Instead, it is perfectly reflected. Light with an energy or direction of propagation outside of the photonic band gap, on the other hand, passes through a photonic crystal.

Effects analogous to doping or defects in semiconductors may also be realized in photonic crystals to further control the interaction of photonic crystals with light. The periodicity of photonic crystals can be perturbed in ways analogous to the introduction of dopants and defects in semiconductors. The periodicity of a photonic crystal is a consequence of a regular and ordered arrangement of macroscopic dielectric media (e.g. rods) within a surrounding medium (e.g. dielectric slab). Effects that interrupt the arrangement of macroscopic dielectric media can be used to break the periodicity to create photonic states within the photonic band gap. Possible ways of perturbing an array of rods in a surrounding dielectric slab, for example, include varying the size, position, optical constants, chemical composition of one or more rods or forming rods from two or more materials. The ability to create photonic states within the photonic band gap provides further flexibility in controlling the frequencies and directions of incident light that are reflected, redirected, localized or otherwise influenced by a photonic crystal.

By introducing defects into photonic crystals, it is possible to control the direction of propagation of light and to confine light. The introduction, for example, of a linear defect in a quasi-two-dimensional photonic crystal confines light and permits use of the photonic crystal as a waveguide for wavelengths within the photonic band gap of the crystal. Point defects can be used to localize light and to form resonant cavities. Examples of photonic crystals and the effect of defects in photonic crystals on the properties of propagating light can be found in the publications: “Linear waveguides in photonic-crystal slabs” by S. G. Johnson et al. and published in Physical Review B, vol. 62, p. 8212-8222 (2000); “Photonic Crystals: Semiconductors of Light” by E. Yablonovich and published in Scientific American, p. 47-55, December issue (2001); Photonic Crystals: Molding the Flow of Light; by J. D. Joannopoulos et al., Princeton University Press (1995); and “Channel drop filters in photonic crystals” by S. Fan et al. and published in Optics Express, vol. 3, p. 4-11 (1998).

It is widely expected that photonic crystals will be significant components in the next-generation information, optical and communication systems. Many people believe that the potential ability to control the propagation of light offered by photonic crystals may exceed the ability of semiconductors to control the propagation of electrons and that a commensurately greater economic benefit will result from the development of new technologies and industries based on photonic crystals and their ability to selectively inhibit, direct or localize the propagation of light in increasingly complex ways. The technological areas in which photonic crystals are projected to make an impact continue to grow in scope. Projected applications include LEDs and lasers that emit light in very narrow wavelength ranges or that are of nanoscopic dimensions, direction selective reflectors, narrow wavelength optical filters, microcavities for channeling light, color pigments, high capacity optical fibers, integrated photonic and electronic circuits that combine photonic crystals and semiconductors to produce new functionality, devices for light confinement, optical switches, modulators, and miniature waveguides.

In order to realize the potential for photonic crystals in integrated optical systems, it is necessary to devise ways to efficiently couple light into photonic crystals. Efficient coupling from conventional fibers and waveguides to photonic crystals and vice versa is one desired objective. In the case of photonic crystals having defects, it is further desirable to develop a capability for the direct coupling of light from a waveguide or other interconnect into the defect. Another important objective is the efficient coupling of light from one photonic crystal to another and from a photonic wire to a photonic crystal (and vice versa).

Although the problem of coupling into photonic crystals has received theoretical attention, much less consideration has been given to the practical problems and designs necessary for the efficient coupling of light into and out of photonic crystals, especially in the context of economically feasible manufacturing methods such as planar fabrication processes. A need exists for practical coupling schemes and devices so that photonic crystals can be successfully and viably integrated with other optical and electronic components of all-optical and optoelectronic systems.

### SUMMARY OF THE INVENTION

This invention provides optical circuits that include a photonic coupling device for delivering light to and from optical components. The photonic coupling devices provide for highly efficient transfer of mode intensity to or from optical elements. High transfer efficiency is achieved between elements interconnected to the instant photonic coupling device and is accomplished through an adiabatic or nearly adiabatic transformation of mode characteristics across a the coupling device.

In one embodiment is presented an optical element that includes a transmitting element, a receiving element and a photonic coupling device interconnected therebetween. An optical signal present in the transmitting element is transferred to the photonic coupling device, propagates through the photonic coupling device and is provided to the receiving element. In a preferred embodiment, the interconnected elements form a portion of an integrated optical circuit. The photonic coupling device permits the efficient transfer and transformation of an optical signal having spatial or mode properties characteristic of the transmitting element to an optical signal having spatial or mode properties characteristics of the receiving element. The spatial profile and/or distribution of signal intensity can be transformed with minimal losses through the use of the instant coupling device.

In a preferred embodiment, the transmitting or receiving elements are elements capable of at least partially confining light, such as waveguides and photonic wires. In another preferred embodiment, the transmitting or receiving elements are photonic crystals. Rod and hole type photonic crystals are within the scope of the instant invention and in a preferred embodiment, the photonic crystal includes a defect that is capable of spatially localizing one or more wavelengths of light or electromagnetic radiation.

The instant photonic coupling devices are designed to transfer optical signals at constant or nearly constant impedance between photonic crystals and other optical elements. In one embodiment, the dielectric constant of the photonic coupling device varies in the direction of propagation of the optical signal and the shape of the photonic coupling device is tapered or otherwise modified to compensate for changes in impedance resulting from the variation in dielectric constant.

In another embodiment, the shape of the photonic coupling device is maintained constant in the direction of propagation of the optical signal and a series of holes (filled or unfilled) is introduced into the coupling device, where the size of the holes varies smoothly to adjust the mode characteristics of the optical signal as it passes through the coupling device.

In one embodiment, the instant photonic coupling device links a transmitting element supporting an optical signal to a receiving photonic crystal and provides for an efficient transfer of the optical signal to the photonic crystal. In a preferred embodiment, the optical signal exits the transmitting element as a guided mode and the instant coupling device transforms the mode characteristics from those of the transmitting element to those best supported by the receiving photonic crystal.

In another embodiment, the instant photonic coupling device links a photonic crystal supporting an optical signal to a receiving element and provides for an efficient transfer of the optical signal to the receiving element. In a preferred embodiment, the optical signal exits the photonic signal as a guided mode and the instant photonic coupling device transforms the mode characteristics from those of the photonic crystal to those best supported by the receiving element in a quasi-adiabatic fashion.

In a preferred embodiment, the photonic crystal connected to the instant photonic coupling device is a slab photonic crystal. In this embodiment, the photonic crystal includes a periodic arrangement of macroscopic dielectric regions distributed within a surrounding dielectric medium or the photonic crystal includes a period arrangement of holes distributed within a surrounding dielectric medium.

In another preferred embodiment, the photonic crystal connected to the instant photonic coupling device includes a defect. Representative defects include linear defects and point defects. In these embodiments the photonic crystal may function as a waveguide, resonator or channel drop filter and coupling efficiency to the defect is maximized.

In yet another embodiment, a photonic wire is included as the receiving or transmitting element and the instant photonic coupling device interconnects the photonic wire to a photonic crystal.

### BRIEF DESCRIPTION OF THE DRAWINGS

FIG. 1. An optical element that includes a photonic coupling element having a tapered end interconnected between a photonic wire and a rod photonic crystal having a linear defect.

FIG. 2. A photonic coupling element having two tapered ends.

FIG. 3. An optical element that includes a photonic coupling element having a taper in hole size interconnected between a photonic wire and a hole photonic crystal having a linear defect.

FIG. 4. A photonic coupling element having tapers in hole size in which one taper includes a series of holes arranged in order of increasing size in a direction along the length of the coupling element and another taper includes a series of holes arranged in order of decreasing size in a direction along the length of the coupling element.

FIG. 5. A photonic coupling element having a tapered end and a taper in hole size.

FIG. 6. An optical element including a photonic coupling element having a hole taper interconnected to a hole photonic crystal having a linear defect.

FIG. 7. An optical element including a photonic coupling element having a hole taper interconnected to a hole photonic crystal having a linear defect.

FIG. 8. An optical element including a photonic coupling element having a hole taper and a photonic groove interconnected to a hole photonic crystal having a linear defect.

FIG. 9. An optical element including a photonic coupling element having a photonic groove with a tapered end interconnected to a hole photonic crystal having a linear defect and tapered boundary holes.

### DETAILED DESCRIPTION OF THE ILLUSTRATED EMBODIMENTS

This invention provides a photonic coupling device that efficiently transfers optical signals, including guided modes, to and from photonic crystals. Efficient transfer is accomplished through a strategy designed to closely preserve impedance along the pathway of optical propagation as the optical signal is transferred from a transmitting element through the photonic coupling device to a receiving element. The benefits associated with conserving impedance as closely as possible during the propagation and transfer of optical signals has been previously described in the co-pending parent application, U.S. patent application Ser. No. 10/855,482 (the '482 application), the disclosure of which is incorporated by reference herein.

The strategy employed in the instant invention recognizes that optical losses are particularly problematic at the interfaces between optical elements in an optical circuit and the instant invention seeks to provide a photonic coupling element that minimizes losses both interfacial losses at the ends of the coupling element as well as propagation losses through the coupling element. The instant photonic coupling element transfers an optical signal from a transmitting element to a receiving element.

In a typical arrangement, the input end of the instant coupling device is interconnected to the output end of a transmitting element (or device) and the output end of the coupling device is interconnected to the input end of the receiving element (or device). In a preferred embodiment, the input and output ends of the coupling element are interconnected at surfaces of the transmitting and receiving elements. In another preferred embodiment, the input end of the coupling element is interconnected at a surface of the transmitting element and the output end of the coupling element is embedded within the receiving element so that spatial overlap of the coupling element with the receiving element occurs. In another preferred embodiment, the input end of the coupling element is embedded within the transmitting element so that spatial overlap of the coupling element with the transmitting element occurs and the output end of the coupling element is interconnected at a surface of the receiving element. In another preferred embodiment, the input end of the coupling element is embedded within the transmitting element so that spatial overlap of the coupling element with the transmitting element occurs and the output end of the coupling element is embedded within the receiving element so that spatial overlap of the coupling element with the receiving element occurs.

In these embodiments, the physical characteristics (e.g. dimensions), chemical characteristics (e.g. material composition) and/or optical constants (e.g. dielectric constant, permittivity) of the transmitting and receiving elements may differ and the role of the coupling device is to facilitate the transition of the optical signal having the mode and propagation characteristics present in the transmitting element to mode characteristics that can be accommodated by the receiving element. The signal exits the transmitting element, enters and propagates through the photonic coupling element, exits the coupling element and enters the receiving element.

When an optical signal passes from one element to another across an interface, or is transmitted through a element that changes its shape or optical constants along the direction of signal propagation, losses in the signal resulting from reflection and/or scattering occurs unless the characteristic impedance remains constant. The instant devices employ an impedance matching and conservation strategy to minimize reflection and scattering losses in order to maximize the transferred power of an optical signal. The instant photonic coupling devices match or approximately match impedance at its interfaces with interconnected transmitting and receiving elements and conserve or approximately conserve impedance along a signal propagation pathway within the device. In a preferred embodiment, the instant photonic coupling devices further effect a transformation of mode characteristics from those of the transmitting element to those compatible with the receiving element, where the physical dimensions and/or optical constants of the coupling element vary along the direction of signal propagation.

As described in the '482 application, the characteristic impedance of a mode propagating in an optical medium or device is influenced by the cross-sectional shape of the medium or device, the profile of the propagating mode or optical signal within the medium or device, and/or the (effective) permittivity (or dielectric constant) of the medium or device. When transferring an optical mode from a transmitting device to a receiving device having different physical dimensions, it is preferable that the coupling device accomplish the necessary change in physical dimensions by varying its size and/or cross-sectional shape along the direction of optical propagation. In order to reduce losses at the input end of the coupling device, it is preferable for the physical dimensions of the input end of the coupling device to match or closely match the physical dimensions of the output end of the transmitting device. In order to reduce losses at the output end of the coupling device, it is preferable for the physical dimensions of the output end of the coupling device to match or closely match the physical dimensions of the input end of the receiving device. Good spatial overlap with the transmitting and receiving elements facilitates the efficient transfer of the intensity and power of the optical mode.

As the physical dimensions or cross-sectional shape of the coupling device vary along the propagation direction in order to effect a transformation of dimensions from those of the transmitting device to those of the receiving device, the characteristic impedance of the coupling device will vary and losses in optical signal will occur unless there is a compensating change in the permittivity or effective permittivity of the device or other effect that serves to counteract changes in the mode profile as the physical dimensions of the coupling device vary. The instant photonic coupling devices achieve such compensation through interactions of the coupling device with the transmitting and/or receiving element that modify the characteristics of the propagating mode or optical signal in a way that offsets the change induced by the varying physical dimensions of the coupling device. The overall result is a photonic coupling device that effects a transformation of mode profile and spatial characteristics from those typical of the transmitting element to those typical of the receiving element in a manner that preserves, or approximately preserves, the impedance of the mode along the pathway of optical propagation between the transmitting and receiving devices. In a preferred embodiment, the compensating changes in the physical dimensions and effective permittivity of the instant photonic coupling device occur gradually along the length of the device. Scattering and reflection losses at the input and output ends of the instant coupling device as well as through the interior of the coupling device are minimized in the instant coupling device.

A photonic coupling device according to the instant invention may convert an input mode (a mode received at the input end of the coupling device) having a particular mode profile into an output mode (a mode delivered at the output end of the coupling device) having a different mode profile when the physical dimensions (e.g. cross-sectional area or shape) of the coupling device vary along the direction of propagation of a mode through the coupling device. A change in the physical dimensions of the coupling device leads to a change in the impedance of the coupling device. In one embodiment of the instant coupling devices, impedance effects due to changes in the shape of the coupling device along the mode propagation pathway are offset or substantially offset through a compensating change in the effective permittivity of the coupling device along the mode propagation pathway so that a coupling device having a constant or substantially constant impedance along the mode propagation pathway is provided. In another embodiment, the compensating change may be accomplished by embedding the coupling device at least partially within the transmitting and/or receiving element, thereby inducing or enabling an interaction of the mode with the transmitting or receiving element as it propagates through the coupling device.

In a preferred embodiment, the instant photonic coupling device couples an optical mode or signal into or out of a photonic crystal. Photonic crystals are optical systems that possess a photonic bandgap. Electromagnetic radiation having an energy within the photonic band gap and propagating in a direction defined by the photonic band gap is blocked and unable to propagate in a photonic crystal. When external light having an energy and direction of propagation within the photonic band gap is made incident to a photonic crystal, it is unable to propagate through the crystal. Instead, it is perfectly reflected. Light with an energy or direction of propagation outside of the photonic band gap, on the other hand, freely passes through the crystal (subject, of course to ordinary absorption and reflection processes). This feature makes photonic crystals essentially perfect reflectors of incident wavelengths that are within the wavelength range and range of propagation directions encompassed by the photonic bandgap.

Photonic crystals include a periodic arrangement of macroscopic dielectric objects (media) interspersed within a surrounding dielectric medium. The periodically arranged objects and surrounding dielectric medium differ in refractive index (dielectric constant) so that a contrast in refractive index between the objects and the surrounding medium is present. Periodicity of the refractive index originating from the periodic arrangement of one dielectric medium within another underlies the formation of a photonic bandgap and dictates the density of photonic states at different frequencies. When a photonic bandgap forms, the wavelengths of electromagnetic radiation within the bandgap are those that are comparable to the periodic spacing in refractive index.

A representative example of a photonic crystal is a material that consists of a flat dielectric slab that contains a periodic arrangement of holes (which may be filled or unfilled) extending in the thin direction and aligned along the lateral dimensions of the slab. Such a material may be viewed as a periodic arrangement of rods comprised of air and corresponds to a photonic crystal in which air is the macroscopic periodically arranged dielectric medium and the slab is the surrounding medium. Another example of a photonic crystal would be a periodic array of cylindrically shaped rods made of a dielectric material supported by a substrate with the space between the rods being filled by air or a dielectric material other than the one from which the rods are made. In such a photonic crystal, the rods correspond to the periodically distributed macroscopic dielectric medium and the material filling the space between the rods corresponds to the surrounding matrix. The precise details of the periodic pattern of rods (or other shape) and the refractive index contrast between the periodic macroscopic dielectric medium and its surroundings influences the properties of the photonic crystal.

Photonic crystals can be formed from a wide variety of macroscopic dielectric media provided that an appropriate refractive index contrast with a surrounding medium can be achieved. As an example, the composition of the holes or rods in the example above is not limited to air. Other materials that present a sufficiently large refractive index contrast with the surrounding flat dielectric slab may be used to form the rods. A periodic lattice of air holes, for example, may be drilled in a flat dielectric slab and subsequently filled with another material to form a photonic crystal. The rod material may have a higher or lower refractive index than the slab material. As another example, a periodic array of rods comprised of a macroscopic dielectric medium such as silicon in air as the surrounding medium represents a photonic crystal.

Important material design considerations include the size, spacing and arrangement of macroscopic dielectric media within a volume of surrounding material as well as the refractive indices of the dielectric objects and surrounding material. The periodicity of the macroscopic dielectric objects can extend in one, two or three dimensions. These considerations influence the magnitude of the photonic band gap, the frequency range of light or other electromagnetic energy (e.g. infrared, microwave etc.) that falls within the photonic band gap and whether the photonic band gap is full (in which case the photonic band gap effect is manifested regardless of the direction of propagation of the incident light) or partial (in which case the photonic band gap effect is manifested for some, but not all, directions of propagation). Other practical considerations are also relevant such as manufacturability, cost, ability to fabricate a periodic array of rods etc.

Effects analogous to doping or defects in semiconductors may also be realized in photonic crystals. An inherent consequence of dopants or defects in semiconductors is a disruption or interruption of the periodicity of the lattice of atoms that constitute the semiconductor. The electronic states associated with dopants or defects are a direct consequence of the local disturbance in periodicity imparted to the semiconductor lattice. Photonic crystals can similarly be perturbed in ways analogous to introducing dopants and defects in semiconductors. Defects can be used to spatially confine light within a photonic crystal. A point defect can be used to localize electromagnetic radiation having a wavelength within the photonic bandgap. This occurs because the localized electromagnetic radiation is unable to escape from the defect due to its inability to propagate into or through the surrounding photonic crystal by virtue of the fact that the localized wavelength is within the photonic bandgap. Linear and planar defects can similarly be used to confine electromagnetic radiation in one or two dimensions within a photonic crystal.

The periodicity of a photonic crystal is a consequence of a regular and ordered arrangement of macroscopic dielectric media within a surrounding medium. Effects that interrupt the arrangement of macroscopic dielectric media can be used to break the periodicity to create localized or extended defect photonic states within the photonic band gap. Defects can be formed in rod array photonic crystals, for example, by perturbing one or more of the rods with respect to other rods in an array. Possible ways of perturbing rods in a surrounding dielectric slab, for example, include varying the size, position, optical constants, chemical composition of one or more rods or forming rods from two or more materials. Perturbation of a single rod provides a point defect that can be used to localize light. Perturbation of a row of rods provides a linear defect that acts to confine light in a channel. Such defects can be used to efficiently transfer light through the crystal without losses. The rods in a row, for example, can be increased or decreased in size relative to the remaining rods of the photonic crystal to form a linear defect and may also be removed altogether. In a hole photonic crystal, the holes in a row can be increased or decreased in size relative to the remaining holes of the photonic crystal to form a linear defect and may also be removed altogether.

The physical dimensions and other characteristics of a photonic crystal can be controlled during fabrication of the photonic crystal. Typical fabrication steps include masking, etching and lithography. As an example, a rod photonic crystal can be prepared from a solid slab of dielectric material by masking the positions where the rods are to be formed and etching around the masks to remove the portions of the dielectric slab between the rods. The depth of etch can be controlled to determine the height of the rods and the mask area and positioning can be used to control the diameter of the rods, the number of rods and the spacing between rods. Hole photonic crystals can be prepared analogously by masking the surrounding medium portion of the photonic crystal and etching the hole positions.

The instant photonic coupling devices permit coupling of optical modes and signals from integrated waveguides to photonic crystals or defects within photonic crystals. Integrated waveguides include single mode and multimode waveguides and photonic wires. Single mode waveguides and photonic wires are useful in applications in which it is desirable to preserve mode characteristics and avoid mode mixing or redistribution of power among multiple modes during signal transmission. Photonic wires are single mode integrated waveguides that exhibit a high refractive index contrast between the core and cladding regions. The high index contrast makes the use of photonic wires beneficial in integrated optical systems because they can be used for the propagation of light across sharp bends with low loss. The combination of single mode behavior and high index contrast is achieved by reducing the cross-sectional area of the wire below a critical value. In a preferred embodiment, the material used to form a photonic wire or other waveguide corresponds to the material of which the rods (in a rod photonic crystal) or the surrounding medium (in a hole photonic crystal) are made so that the photonic wire or waveguide can be fabricated in an integrated fashion with the photonic crystal to provide an integrated optical element.

Further explanation of the principles of operation and design of the instant coupling devices is provided in the following illustrative examples.

### EXAMPLE 1

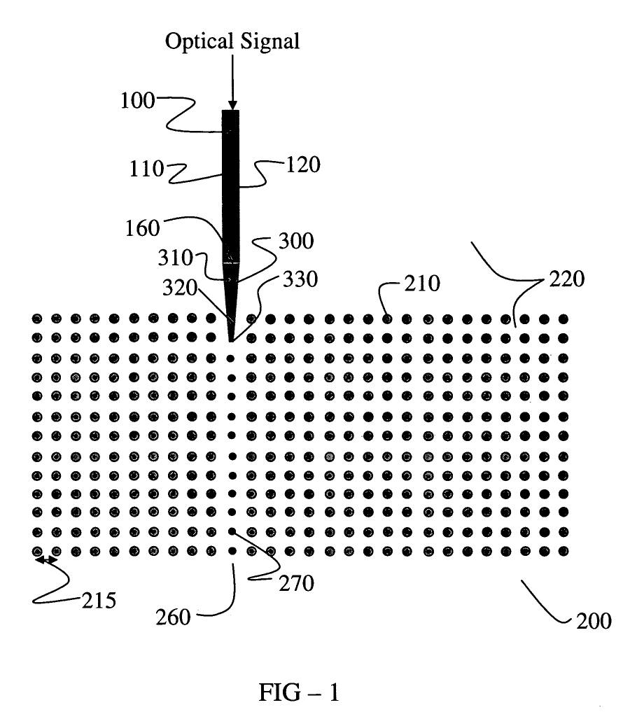

In this example a photonic coupling device that efficiently transfers an optical signal from a photonic wire waveguide to a rod-based photonic crystal (or vice versa) is described. FIG. 1 is a top view depiction that shows the coupling of photonic wire 100 to photonic crystal 200 via photonic coupling device 300. An optical signal (single mode or multimode) propagating in photonic wire 100 is transferred to photonic crystal 200 through photonic coupling device 300. Photonic wire 100 may be viewed as a transmitting element interconnected to photonic coupling device 300 and photonic crystal 200 may be viewed as a receiving element interconnected to photonic coupling device 300.

A photonic crystal includes a periodic arrangement of macroscopic dielectric objects interspersed within a surrounding dielectric medium. In this embodiment, photonic crystal 200 includes periodically arranged dielectric objects in the form of rods 210 interspersed within a surrounding dielectric medium 220. The periodically arranged rods 210 and surrounding medium 220 are comprised of one or more dielectric materials, where the rods 210 have a higher refractive index than surrounding medium 220. As an example, rods 210 may comprise a dielectric material such as silicon, while the surrounding dielectric medium 220 may comprise air. The periodic spacing of the rods 215 corresponds to the distance between the centers of adjacent rods. As indicated hereinabove, the periodic spacing of a photonic crystal is a design parameter that can be varied to define the properties of the photonic bandgap and establish the magnitude and range of wavelengths of electromagnetic radiation that are within and without the photonic bandgap. The rod diameter is a fraction of the periodic spacing and is another design parameter. The rod height is another design parameter that can be controlled during fabrication. The rods of this example have a circular cross-section. Other embodiments include rods having other cross-sectional shapes including square, rectangular, hexagonal and triangular.

Representative dimensions for the photonic crystal of the embodiment of FIG. 1 are as follows: the periodic spacing 215 is 434 nm, the diameter of rods 210 is 191 nm, the diameter of defect rods 270 is 130 nm, the height of rods 210 and 270 is 781 nm and the height of photonic wire 100 is 781 nm.

Photonic crystal 200 further includes defect 260 that includes defect rods 270. In the embodiment of FIG. 1, the defect 260 is a linear defect obtained by reducing the diameter of a column of rods. The presence of defect rods 270 in the photonic crystal creates states within the photonic bandgap that allow the photonic crystal to support optical signals having selected wavelengths. Optical signals having a wavelength compatible with the photonic bandgap state created by the linear defect 260 can be transmitted along the defect and transmitted through the photonic crystal. Since the wavelength is otherwise within the photonic band gap, the optical signal is confined to the linear defect and is precluded by Bragg reflection at the boundaries of the defect from propagating to other parts of the photonic crystal. By varying the relative sizes of the defect rods 270 and normal (non-defect) rods 210, the wavelength supported by the defect state can be designed to match particular signals of interest. In the embodiment of FIG. 1, defect rods 270 are comprised of the material used to form rods 210. In other embodiments, the defect rods may be comprised of a different material and may be larger in size than the normal rods.

The photonic wire 100 has a width in the plane of the top view of FIG. 1 that is no greater than the period spacing of rods in photonic crystal 200. The photonic wire 100 has planar sides 110 and 120 normal to the plane of the top view of FIG. 1. In the embodiment shown in FIG. 1, the height of the photonic wire 100 matches the height of the periodically arranged rods 210 and the photonic wire 100 is comprised of the material used to form rods 210.

Photonic coupling device 300 includes non-embedded portion 310 and embedded portion 320, where the embedded portion 320 spatially overlaps a portion of photonic crystal 200. In the embodiment of FIG. 1, photonic coupling device 300 is comprised of the material used to form photonic wire 100 and rods 210. Photonic coupling device 300 has a tapered, wedge-like cross-section in top view. The taper gradually reduces in width and cross-sectional area along the direction of propagation of the optical signal and extends from the interfacial boundary 160 of the output end of photonic wire 100 with the input end of photonic coupling device 300 into the interior of photonic crystal 200 and terminates at tip region 330. In a preferred embodiment, the coupling device 300 seamlessly interfaces with photonic wire 100 at the interfacial boundary 160 so that losses are minimized when the optical signal propagates from photonic wire 100 into photonic coupling device 300. The taper length is the distance from output end 160 of the photonic wire to the tip 330.

When an optical signal propagates through coupling device 300, the cross-section of the device narrows and the spatial extent of the optical signal increasingly extends beyond the physical boundaries of the coupling device as the signal propagates from interface 160 toward the tip 330. A greater spatial extent of the optical signal act, acting alone, would serve to decrease the effective impedance encountered by the signal during propagation. The resulting variation in effective impedance along the direction of propagation would, if not counteracted, promote loss of signal strength. As the spatial extent of the optical signal increases during propagation from interface 160 to tip 330, however, the optical signal also increasingly samples the low index surrounding region 220. As a result, the effective permittivity encountered by the optical signal as it propagates from interface 160 toward tip 330 decreases. Since a decrease in effective permittivity, acting alone, serves to increase the effective impedance, this effect acts to counteract the increase in effective impedance resulting from the tapering of the coupling device.

The effects of the decreased cross-sectional area of the coupling device 300 and the decreased effective permittivity in the direction of propagation of the optical signal from interface 160 to tip 330 have offsetting influences on the effective impedance and can be balanced to provide for propagation of the optical signal under constant, or nearly constant, impedance conditions. Losses associated with the propagation of the optical signal through coupling device 300 are minimized by incorporating a gradual taper in the design. A gradual taper leads to a gradual variation in the spatial extent of the propagating optical signal and provides a smooth transition in the spatial characteristics of the optical signal as well as in the environment it senses during propagation. In a preferred embodiment, the taper length is at least 3 times the periodic spacing 215 of the rods 210 of photonic crystal 200. In a more preferred embodiment, the taper length is at least 5 times the periodic spacing 215 of the rods 210 of photonic crystal 200. In a still more preferred embodiment, the taper length is at least 7 times the periodic spacing 215 of the rods 210 of photonic crystal 200.

As the optical signal propagates toward tip 330, it ultimately enters the embedded portion 320 of coupling device 300 at which point the spatially extending optical signal begins to spatially overlap and interact with photonic crystal 200 as it propagates toward tip 330. In the embodiment of FIG. 1, photonic wire 100 and photonic coupling device 300 are aligned along the linear defect 260 of photonic crystal 200. As the optical signal approaches tip 330, it increasingly senses the photonic crystal and its propagation environment progressively transforms into that of linear defect 260. As a result, abrupt changes in the characteristics and propagation environment of the optical signal are avoided when the signal exits tip 330 and enters the photonic crystal. During propagation through the coupling device, the optical signal progressively delocalizes from the coupling device and progressively localizes in the photonic crystal.

In a preferred embodiment, the optical signal has a wavelength that corresponds to a wavelength state within the photonic bandgap of photonic crystal 200 defined by linear defect 260. In this embodiment, when the optical signal is transferred to the photonic crystal, it enters and remains localized within the linear defect 260 due to Bragg reflection at the boundaries of the defect. As a result, the optical signal can freely traverse the photonic crystal along linear defect 260 and exit the photonic crystal. The exiting signal can be transferred to another optical element or otherwise harnessed.

The photonic coupling device 300 may also function in reverse and provide for the transfer of an optical signal originating from linear defect 260 into photonic wire 100.

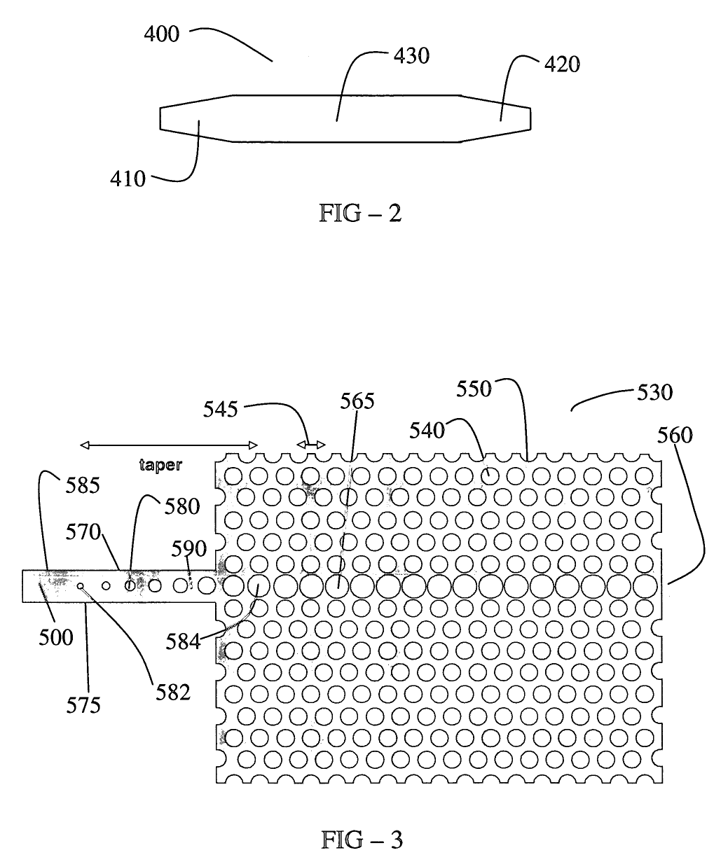

In related embodiments, photonic coupling devices may be combined to provide interconnection element that can be used to transfer optical signals between photonic crystals. FIG. 2, for example, illustrates interconnection device 400 that comprises photonic coupling devices 410 and 420 according to the instant invention in combination with waveguide segment 430, where the waveguide segment 430 may be a photonic wire segment. The interconnection device can be used to interconnect two photonic crystals by connecting coupling devices 410 and 420 to separate photonic crystals, where each connection is completed in a manner analogous to that shown in FIG. 1.

### EXAMPLE 2

In this example, a photonic coupling device for the efficient transfer of an optical signal from a photonic wire to a hole-based photonic crystal (or vice versa) is demonstrated. FIG. 3 is a top view depiction that shows the coupling of photonic wire 500 to photonic crystal 530 via photonic coupling device 570. An optical signal (single mode or multimode) propagating in photonic wire 500 is transferred to photonic crystal 530 through photonic coupling device 570. Photonic wire 500 may be viewed as a transmitting element interconnected to photonic coupling device 570 and photonic crystal 530 may be viewed as a receiving element interconnected to photonic coupling device 570.

In this embodiment, photonic crystal 530 is a hole photonic crystal that includes periodically arranged holes 540 interspersed within a surrounding medium 550. The periodically arranged holes 540 and surrounding medium 550 are comprised of one or more dielectric materials, where the holes 540 have a lower refractive index than surrounding medium 550. The holes may contain air or may be filled with some other material. The periodic spacing of the holes 545 corresponds to the distance between the centers of adjacent holes. As indicated hereinabove, the periodic spacing of a photonic crystal is a design parameter that can be varied to define the properties of the photonic bandgap and establish the magnitude and range of wavelengths of electromagnetic radiation that are within and without the photonic bandgap. The hole diameter is a fraction of the periodic spacing and is another design parameter. The hole height is another design parameter that can be controlled during fabrication.

Representative dimensions for the photonic crystal of the embodiment of FIG. 3 are as follows: the periodic spacing 545 is 375 nm, the diameter of holes 540 is 225 nm, the diameter of defect holes 565 is 300 nm, the height of holes 540 and 565 is 225 nm and the height of photonic wire 500 is 225 nm.

Photonic crystal 530 further includes defect 560 that includes defect holes 565. In the embodiment of FIG. 3, the defect 560 is a linear defect obtained by increasing the diameter of a row of holes. The presence of defect holes 565 in the photonic crystal creates states within the photonic bandgap that allow the photonic crystal to support optical signals having selected wavelengths. Optical signals having a wavelength compatible with the photonic bandgap state created by the linear defect 560 can be transmitted along the defect and transmitted through the photonic crystal. Since the wavelength is otherwise within the photonic band gap, the optical signal is confined to the linear defect and is precluded by Bragg reflection at the boundaries of the defect from propagating to other parts of the photonic crystal. By varying the relative sizes of the defect holes 565 and normal (non-defect) holes 540, the wavelength supported by the defect state can be designed to match particular signals of interest.

The photonic wire 500 has a width in the plane of the top view of FIG. 3 that is no greater than about twice the period spacing of rods in photonic crystal 530. The photonic wire 500 has planar sides 575 and 585 normal to the plane of the top view of FIG. 3. In the embodiment shown in FIG. 3, the height of the photonic wire 500 matches the height of the photonic crystal 530.

Photonic coupling device 570 includes a series of holes 580 that are tapered in size. In the embodiment of FIG. 3, the hole size increases in the direction of propagation of the optical signal. The variation in the size of the holes may be referred to herein as a taper in the size of the holes, hole taper or taper. The hole taper extends from its smallest hole 582 near the input end of the coupling device to its largest hole 584 embedded within photonic crystal 530. The hole taper thus includes a non-embedded portion and an embedded portion. The approximate extent of the hole taper is indicated by the arrow labeled “taper” in FIG. 3. The largest hole of the hole taper matches or closely approximates the size of defect holes 565. The hole taper of the coupling device 570 thus provides a gradual transition in hole size up to the size of defect holes 565 and thus provides a gradual transition from the impedance and propagation environment of the optical signal in photonic wire 500 to those of defect 560 in photonic crystal 530. The small hole size at the input end of the coupling device facilitates efficient coupling of an optical signal from photonic wire 500 to the input end of the coupling device and the larger hole size at the output end of the coupling device facilitates efficient coupling of the optical signal from photonic coupling device to defect 560 of photonic crystal 530. The coupling device 570 also includes surrounding medium 590 that surrounds the holes 580. In the embodiment of FIG. 3, surrounding medium 590 is comprised of the same material as photonic wire 500 and surrounding medium 550 of photonic crystal 530.

When an optical signal propagates through coupling device 570 and encounters the holes 580, the signal increasingly localizes within the holes. Since the hole taper is comprised of a series of holes that gradually increase in size, the transfer of the optical signal from surrounding medium 590 to the holes 580 occurs gradually and the localization of the signal into the holes occurs in a manner that preserves or approximately preserves the impedance encountered by the optical signal as it propagates through the coupling device. Losses associated with the propagation of the optical signal through coupling device 570 are minimized by incorporating a gradual hole taper in the design. A gradual taper leads to a gradual variation in the spatial extent of the propagating optical signal and provides a smooth transition in the spatial characteristics of the optical signal as well as in the permittivity of the environment it senses during propagation. In a preferred embodiment, the hole taper length is at least 3 times the periodic spacing 545 of the holes 540 of photonic crystal 530. In a more preferred embodiment, the taper length is at least 5 times the periodic spacing 545 of the holes 540 of photonic crystal 530. In a still more preferred embodiment, the taper length is at least 7 times the periodic spacing 545 of the holes 540 of photonic crystal 530.

As the optical signal propagates through coupling device 570, it ultimately enters the embedded portion at which point the optical signal begins to become influenced by and interact with photonic crystal 530. In the embodiment of FIG. 3, photonic wire 500 and photonic coupling device 570 are aligned along the linear defect 560 of photonic crystal 530. As the optical signal approaches the output end of the coupling device, it increasingly senses the photonic crystal and its propagation environment progressively transforms into that associated with holes 565 of linear defect 560. As a result, abrupt changes in the characteristics and propagation environment of the optical signal are avoided when the signal exits the coupling device and enters the photonic crystal.

In a preferred embodiment, the optical signal has a wavelength that corresponds to a wavelength state within the photonic band gap of photonic crystal 530 defined by linear defect 560. In this embodiment, when the optical signal is transferred to the photonic crystal, it enters and remains localized within the linear defect 560 due to Bragg reflection at the boundaries of the defect. As a result, the optical signal can freely traverse the photonic crystal along linear defect 560 and exit the photonic crystal. The exiting signal can be transferred to another optical element or otherwise harnessed.

The photonic coupling device 570 may also function in reverse and provide for the transfer of an optical signal originating from linear defect 560 into photonic wire 500.

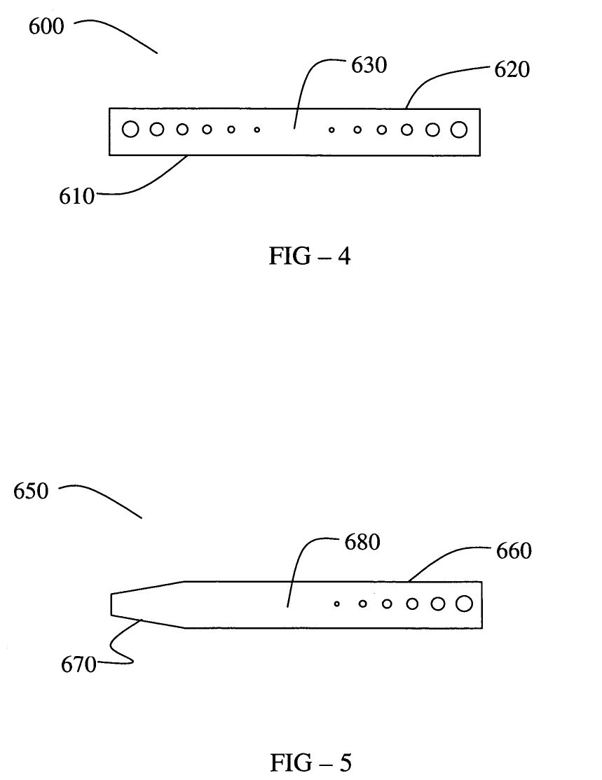

In related embodiments, photonic coupling devices may be combined to provide interconnection element that can be used to transfer optical signals between hole photonic crystals. FIG. 4, for example, illustrates interconnection device 600 that comprises photonic coupling devices 610 and 620 according to the instant invention in combination with waveguide segment 630, where the waveguide segment 630 may be a photonic wire segment. The interconnection device can be used to interconnect two photonic crystals by connecting coupling devices 610 and 620 to separate photonic crystals, where each connection is completed in a manner analogous to that shown in FIG. 3.

FIG. 5 shows a related interconnection device that can be used to transfer optical signals back and forth between rod photonic crystals and hole photonic crystals. The interconnection device 650 includes coupling device 660 that permits efficient coupling to a hole photonic crystal as described in EXAMPLE 2 hereinabove, coupling device 670 that permits efficient coupling to a rod photonic crystal as described in EXAMPLE 1 hereinabove and waveguide or photonic wire segment 680.

### EXAMPLE 3

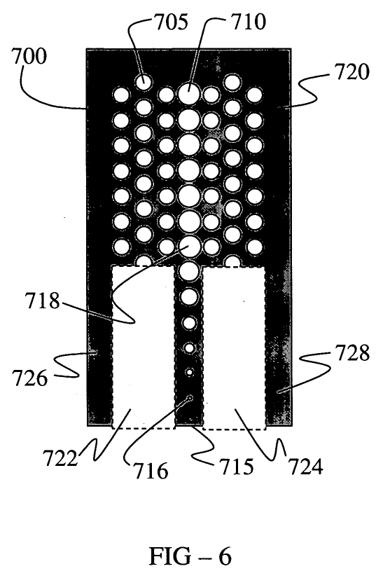

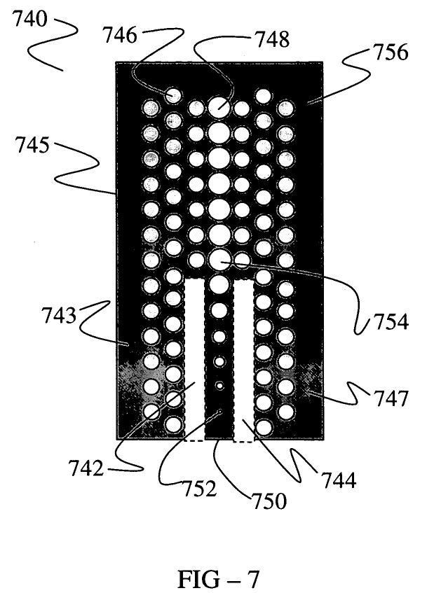

In this example, a variation of the embodiment of EXAMPLE 2 is described. FIG. 6 shows a top view depiction of hole photonic crystal 700 that includes holes 705 and defect holes 710. The defect holes form a linear defect in the photonic crystal. Photonic coupling device 715 is connected to photonic crystal 700 and includes a hole taper extending from small hole 716 to large hole 718. The hole taper of the embodiment of this example includes 7 holes. Photonic coupling device 715 introduces an optical signal into the linear defect of photonic crystal 700 as described in EXAMPLE 2 hereinabove. Photonic coupling device 715 may be connected to a photonic wire or other waeguiding device to receive the optical signal that is introduced into photonic crystal 700.

Photonic crystal 700 and photonic coupling device 715 are fabricated from a common substrate 720. In the embodiment of FIG. 6, the substrate material forms the material surrounding the holes 705 and defect holes 710 of photonic crystal 700 as well as the holes that form the hole taper of photonic coupling device 715. The various holes can be formed by selectively etching or otherwise removing the substrate material to form holes of the appropriate sizes and positions. As described hereinabove, the holes may be filled with air or some other dielectric material having a lower index of refraction than substrate 720. To form photonic coupling device 715, regions 722 and 724 of the substrate material are removed. As in the case of holes, regions 722 and 724 may be left unfilled (filled with air) or filled with a material having a lower refractive index than substrate material 720.

In the embodiment of FIG. 6, the regions 722 and 724 are sufficiently wide to prevent leakage of an optical signal contained in photonic coupling device 715 into side regions 726 and 728 of substrate 720. Confinement of an optical signal improves as the width of regions 722 and 724 increases.

This example represents a typical embodiment in which a photonic crystal with defect and a photonic coupling device are fabricated in a common process. Other waveguiding or photonic elements may also be formed and patterned from the same substrate to provide a series of optically connected integrated optical components.

### EXAMPLE 4

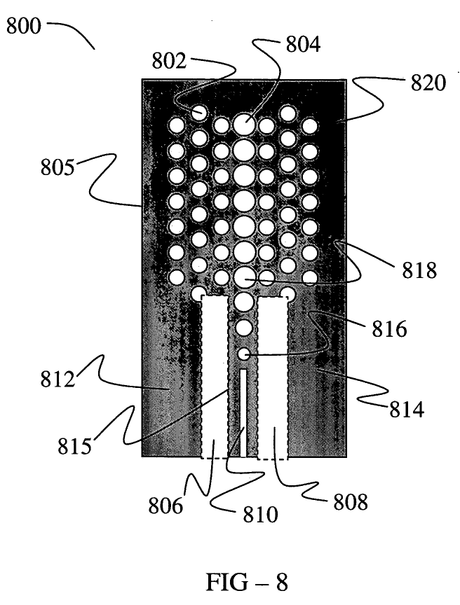

In this example, an integrated optical element that permits the transfer of an optical signal back and forth between a photonic coupling device and a photonic crystal is described. FIG. 7 shows in top view integrated element 740 that includes photonic crystal 745 and photonic coupling device 750. Photonic crystal 745 and photonic coupling device 750 are analogous to the hole photonic crystal and photonic coupling devices described in EXAMPLES 2 and 3 hereinabove. Photonic crystal 745 is a hole photonic crystal with a linear defect and includes holes 746 along with defect holes 748. Photonic coupling device 750 includes a hole taper beginning with small hole 752 and ending with large hole 754. The hole taper of the embodiment of this example includes 7 holes. The element 740 further includes rectangular regions 742 and 744.

Integrated element 740 includes surrounding material 756 that surrounds holes 746, defect holes 748 and the holes comprising the hole taper of photonic coupling device 750. The element 740 can be fabricated from a substrate comprising surrounding material 756. The holes 746, defect holes 748, taper holes of photonic coupling device 750, and rectangular regions 742 and 744 can be formed by masking adjacent surrounding portions of the substrate and etching or otherwise removing (e.g. through lithography) the portions of the substrate material as necessary to form the desired hole or rectangular feature. The holes and rectangular regions may be left unfilled (filled with air) or filled with a material having a lower refractive index than surrounding material 756.

The embodiment of this example differs from that of the embodiment of EXAMPLE 3 in that the rectangular regions 742 and 744 are narrower than regions 722 and 724. Narrower rectangular regions may be desirable from a fabrication viewpoint since it is easier to remove a lesser amount of material to form narrower regions adjacent to a photonic coupling device. Wide regions, such as regions 722 and 724 in EXAMPLE 3 hereinabove, may require additional processing time.

As described in EXAMPLE 3 hereinabove, however, narrow rectangular regions 742 and 744 adjacent to photonic coupling device 750 may enable leakage or loss of an optical signal contained in the coupling device to side regions 743 and 747 of element 740. In order to prevent such losses, the embodiment of EXAMPLE 4 includes a continuation of holes 746 into side regions 743 and 747. The presence of holes 746 provides a photonic bandgap that acts to reflect any optical signal having a frequency within the bandgap. Loss of an optical signal within the photonic bandgap from photonic coupling device 750 into side regions 743 and 747 is thereby inhibited or prevented. An optical signal propagating through photonic coupling device 750 is thus efficiently transferred to photonic crystal 745 and localizes within defect holes 748.

### EXAMPLE 5

In this example, an integrated optical element that transfers light back and forth between a photonic coupling device having a photonic groove and a photonic crystal is described. FIG. 8 shows in top view integrated optical element 800 that includes photonic crystal 805 and photonic coupling device 815. The photonic crystal 805 is a hole photonic crystal as described in EXAMPLES 2, 3, and 4 hereinabove and includes holes 802, defect holes 804 arranged to form a linear defect, and surrounding material 820. Photonic coupling device 815 includes photonic groove 810 and a hole taper having four holes extending from small hole 816 to large hole 818. Photonic coupling device 815 is bounded by rectangular regions 806 and 808, which in turn are bounded by side regions 812 and 814. Photonic coupling device 815 is partially embedded in photonic crystal 805 and is aligned with defect holes 804.

Rectangular regions 806 and 808, photonic groove 810, holes 802, the hole taper of photonic coupling device 815, and defect holes 804 are formed via removal of a portion of surrounding material 820 in the indicated regions. Feature formation can be accomplished through appropriate masking and removal steps as described hereinabove and the features can be left filled with air or can be filled with a material having a lower refractive index than surrounding material 820.

In this embodiment, rectangular regions 806 and 808 are sufficiently narrow to permit loss of an optical signal from photonic coupling device 815 to side portions 812 and 814. Such loss is inhibited or avoided through inclusion of photonic groove 810 in photonic coupling device 815. An optical signal propagating through photonic coupling device 815 localizes in photonic groove 810 and this localization inhibits signal loss into side regions 812 and 814, even in the absence of holes therein. As an optical signal propagates through photonic groove 810 into the interior of element 800, it encounters small hole 816 of the hole taper. Further propagation of the optical signal into the defect holes 804 of the linear defect of photonic crystal 805 occurs via the hole taper. As the signal passes through the hole taper of photonic coupling device 815, it progressively localizes into the holes and experiences a smooth transition from the environment of photonic coupling device 815 to the environment of the linear defect of photonic crystal 805.

### EXAMPLE 6

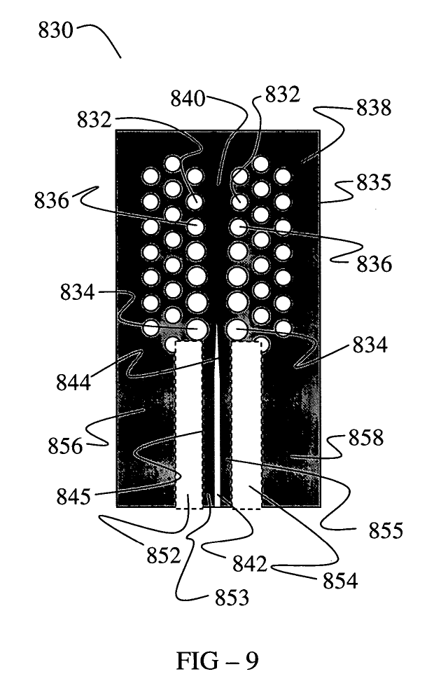

In this example, an integrated optical element that transfers light back and forth between a photonic coupling device having a photonic groove and a photonic crystal is described. FIG. 9 shows in top view integrated optical element 830 that includes photonic crystal 835 and photonic coupling device 845 within surrounding material 838. The photonic crystal 835 is a hole photonic crystal that includes periodic holes 832 and waveguiding channel 840. Channel 840 corresponds to an absence of holes and constitutes an interruption of the peridocity of the holes 832. As such, channel 840 constitutes a defect in photonic crystal 835 and provides a photonic bandgap state that can be used to localize an optical signal having an appropriate frequency. Channel 840 is bounded on both sides by tapered boundary holes that extend from large hole 834 to small hole 836.

Large hole 834 is preferably in the range of 10%-90% larger than periodic holes 832 with small hole 836 having a size intermediate between the sizes of large hole 834 and periodic hole 832. The taper of boundary holes extending from large hole 834 to small hole 836 preferably includes holes having at least three different sizes and preferably the tapered boundary holes decrease monotonically in size from large hole 834 to small hole 836. In the embodiment of FIG. 9, periodic holes 832 have a diameter of 225 nm with a period spacing of 375 nm.

Photonic coupling device 845 includes photonic groove 842 having a tapered end region 844. Photonic coupling device 845 is bounded by rectangular regions 852 and 854, which in turn are bounded by side regions 856 and 858 and is partially embedded in photonic crystal 835. Rectangular regions 852 and 854, photonic groove 842, end region 844, holes 832, the boundary hole tapers extending from large hole 834 to small hole 836 of channel 840 are formed via removal of a portion of surrounding material 838 in the indicated regions. Feature formation can be accomplished through appropriate masking and removal steps as described hereinabove and the features can be left filled with air or can be filled with a material having a lower refractive index than surrounding material 838.

As described in EXAMPLE 5 hereinabove, an optical signal propagating in photonic coupling device 845 localizes in photonic groove 842 and the presence of photonic groove 842 inhibits or prevents loss of the optical signal into side regions 856 and 858 of integrated element 830. The degree of localization of the optical signal in photonic groove 845 can be controlled through appropriate selection of the width of photonic groove 845 relative to the widths of adjacent dielectric regions 853 and 855. In many circumstances, the optical signal would localize in higher index adjacent dielectric regions 853 and 855. An optical signal in dielectric region 853 has an electric field that extends beyond the boundaries of region 853 into both groove region 845 and dielectric region 855, where the sense of the electric field in region 855 is opposite that of the electric field in region 853. Similarly, an optical signal in dielectric region 855 has an electric field that extends beyond the boundaries of region 855 into both groove region 845 and dielectric region 853, where the sense of the electric field in region 853 is opposite that of the electric field in region 855. By appropriately adjusting the relative widths of dielectric regions 853 and 855 along with the width of groove region 845, it is possible to create an interference condition in dielectric regions 853 and 855 that results in a cancellation of electric field intensity in those regions. The net electric field in region 853, for example, includes contributions from both the optical signal confined in region 853 and that portion of the optical signal originating in region 855 that extends beyond the boundaries of region 855 into region 853. The two contributions are opposite in sense and can be made to compensate (or nearly compensate) for each other by appropriately adjusting the widths of regions 853, 855, and 845 to create a condition of destructive interference in region 853 of the two contributions to the net electric field therein. An analogous condition of destructive can be created in region 855 so that the only region of non-zero electric field strength is photonic groove region 845. The optical signal accordingly localizes therein. In the embodiment of FIG. 6, for example, the width of photonic groove 845 is 100 nm and the widths of adjacent dielectric regions 853 and 855 is 200 nm. Similar reasoning is applicable to the embodiment of EXAMPLE 5 hereinabove.

When the optical signal propagates into end region 844 of photonic groove 842, the taper reduces the cross-sectional area in the direction of propagation and the optical signal gradually extends beyond the spatial confines of end region 844 in a manner analogous to that described in EXAMPLE 1 hereinabove. The behavior of an optical signal in tapered end region 844 is analogous to the behavior of an optical signal in the tapered photonic coupling device 300 of FIG. 1. As the optical signal propagates toward the end of tapered region 844, it begins to delocalize and as it approaches large holes 834, it begins to interact with and partially localize therein. Upon further propagation into photonic crystal 835, the optical signal encounters tapered boundary holes that progressively decrease in size and, if the signal has a wavelength in accord with the photonic bandgap state of defect channel 840, is progressively expelled or reflected away from the tapered boundary holes into channel 840 where it remains confined due to the photonic bandgap of surrounding holes 832.

The combined effect of the tapering of end region 844 of photonic groove 842 and the decreasing of hole size from large holes 834 to small holes 836 is to provide a smooth, gradually and nearly adiabatic transition of the environment encountered by a propagating optical signal from that associated with photonic coupling device 845 to that of channel region 840 of photonic crystal 835. As a result, an efficient transfer of the optical signal from the photonic coupling device 845 to photonic crystal 835 occurs.

In an alternate embodiment of the integrated element of this example, the tapered end region 844 can be replaced by a series of holes that decrease in size to form a hole taper extending from photonic groove 842. The large hole of the hole taper is positioned adjacent to photonic groove 842 and is aligned therewith and additional holes of the taper, also aligned with photonic groove 842, extend away from photonic groove 842 and decrease in size with the smallest hole being positioned at approximately the location of the tip of end region 844. In this embodiment, the optical signal propagates along photonic groove 842 and delocalizes into the holes of the taper extending away from the groove. As the holes decrease in size and the signal propagates toward channel 840, the signal begins to interact with and delocalize onto large holes 834 and other holes of the boundary holes as described hereinabove. Ultimately, the signal becomes localized within channel 840 and is confined therein by the photonic bandgap of photonic crystal 835.

In a further embodiment related to this example, the waveguide channel 840 may correspond to an input bus of a channel drop filter, such as the ones described in U.S. Pat. Nos. 6,859,304 and 6,130,969, the disclosures of which are incorporated by reference herein.

As described hereinabove, the instant photonic coupling devices may include a tapered end or shape, a hole taper, and/or a photonic groove. The instant photonic coupling devices provide for a gradual, smooth and approximately adiabatic transition of the propagation environment of an optical signal from that of a transmitting element to that of a receiving element. In a preferred embodiment, the instant photonic coupling device is interconnected between a transmitting element and a receiving element in an integrated optical circuit. The transmitting and receiving elements may be waveguides, dielectric media, photonic wires, and/or photonic crystals.

In a typical embodiment herein, the input end of the instant coupling device is physically connected to the transmitting element and the output end of the instant coupling device is physically connected to the receiving element. The optical signal passes through the instant coupling device along an interconnection pathway. The instant device minimizes coupling losses by providing one or more of the following: adequate spatial overlap at the input end with the transmitting device to provide high acceptance of the optical signal exiting the transmitting element, close index or impedance matching at the input end with the transmitting element to minimize reflection losses upon acceptance, constant or approximately constant impedance of the optical signal during transmission through the coupling device, close index or impedance matching at the output end with the receiving element to minimize reflection losses during transfer of the optical signal from the photonic coupling device to the receiving element and adequate spatial overlap of the photonic coupling device with the receiving element at the output end of the photonic coupling device to promote high acceptance of the signal by the receiving element.

Interconnection of the instant photonic coupling device with an interconnected transmitting or receiving element can occur by embedding or partially embedding the instant coupling device within the interconnected element or by making physical or optical contact without embedding.

EXAMPLES 1-6 described hereinabove represent illustrative examples of embodiments of photonic coupling devices and optical elements within the scope of the instant invention. Photonic crystal components of the instant optical elements comprise a dielectric material that acts to surround a periodic arrangement of discrete dielectric objects, where the dielectric constant of the discrete dielectric objects differs from the dielectric constant of the surrounding dielectric material. The discrete dielectric objects may have a higher or lower dielectric constant than the surrounding dielectric material. The discrete dielectric objects can have a circular cross-sectional shape or another cross-sectional shape such as square, rectangular, hexagonal or triangular.

In the rod photonic crystal 200 of EXAMPLE 1, the rods 210 have a circular cross-section and correspond to periodically arranged discrete dielectric objects within surrounding dielectric material 220 where the dielectric constant of rods 210 is greater than the dielectric constant of surrounding dielectric material 220. In the hole photonic crystal portions of the embodiments of EXAMPLES 2-6, the holes correspond to periodically arranged dielectric objects within a surrounding dielectric material. The holes have a circular cross-section and may contain air or another gas or may be filled with a liquid or solid phase dielectric material.

Preferred embodiments of the photonic coupling devices of the instant optical elements include a dielectric material that acts to surround a plurality of discrete dielectric regions, where the discrete dielectric regions have a dielectric constant that differs from the dielectric constant of the surrounding dielectric material. The dielectric constant of the discrete dielectric regions may be greater than or less than the dielectric constant of the surrounding material. The discrete dielectric regions can have a circular cross-sectional shape or another cross-sectional shape such as square, rectangular, hexagonal or triangular. In embodiments in which the discrete dielectric regions are holes, the holes may contain air or another gas or may be filled with a liquid or solid phase dielectric material.

The preferred embodiments of the instant coupling devices include a two or more discrete dielectric regions having two or more sizes, where the size of a dielectric region refers to a characteristic dimension or area of the cross-sectional shape of the dielectric region. In a preferred embodiment, the discrete dielectric regions include three or more sizes and in a more preferred embodiment, the discrete dielectric regions include five or more sizes. The discrete dielectric regions are positioned between the input end and output end of the photonic coupling device and may be arranged in various patterns. In a preferred embodiment, the discrete dielectric regions all have the same cross-sectional shape. In another preferred embodiment, centers of the discrete dielectric regions are collinear. In a more preferred embodiment, centers the collinear discrete dielectric regions are aligned along the central axis extending between the input and output ends of the photonic coupling device. In other preferred embodiments, the discrete dielectric regions are arranged in order of increasing or decreasing size in a direction extending between the input and output ends of the photonic coupling device.

In the embodiment of EXAMPLE 2, photonic coupling device 570 includes surrounding dielectric medium 590 that surround discrete dielectric regions in the form of holes 580 having a circular cross-section. The discrete dielectric regions 580 are arranged in order of increasing size between the input end and output end of photonic coupling device 570 to form a hole taper as described hereinabove and have centers that are collinear and aligned along the central axis of photonic coupling device 570. The number of discrete dielectric regions 580 included in photonic coupling device 570 is greater than five. Photonic coupling devices 715 and 750 of the embodiments of EXAMPLES 3 and 4, respectively, may be similarly described.

Other embodiments of the instant invention include photonic grooves, where the photonic groove comprises a continuous region of dielectric material surrounded or partially surrounded by a surrounding dielectric material. The dielectric constant of the photonic groove may be higher or lower than the dielectric constant of the surrounding material. The photonic groove may be filled with air or another gas as well as with a liquid or solid dielectric material. One preferred cross-section of the photonic groove is rectangular. Other preferred photonic grooves include a tapered end. In a preferred embodiment, the photonic groove has a central axis aligned along the length direction of the photonic coupling device. In a more preferred embodiment, the central axis of the photonic groove is collinear with or aligned along the central axis of the photonic coupling device.

In the embodiment of EXAMPLE 5, photonic coupling device 815 includes photonic groove 810 surrounded by surrounding dielectric material 820. Photonic groove 810 has a rectangular cross-section and a central axis that is collinear with the central axis of photonic coupling device 815. In the embodiment of EXAMPLE 6, photonic coupling device 845 includes photonic groove 842 surrounded by surrounding dielectric material 838 and having a rectangular cross-section. Photonic groove 842 further includes a tapered end 844 and has a central axis that is collinear with the central axis of photonic coupling device 845.

Materials suitable for use as the surrounding material, discrete dielectric objects, discrete dielectric regions, photonic groove or fill material for holes or grooves are dielectric materials. Preferred dielectric materials include silicon, germanium and dielectric materials comprising silicon or germanium. Oxides, including metal oxides, are another preferred dielectric material.

The disclosure and discussion set forth herein is illustrative and not intended to limit the practice of the instant invention. While there have been described what are believed to be the preferred embodiments of the instant invention, those skilled in the art will recognize that other and further changes and modifications may be made thereto without departing from the spirit of the invention, and it is intended to claim all such changes and modifications that fall within the full scope of the invention. It is the following claims, including all equivalents, in combination with the foregoing disclosure and knowledge commonly available to persons of skill in the art, which define the scope of the instant invention.

1. An optical element comprising a photonic coupling device, said photonic coupling device having an input end and an output end, said photonic coupling device comprising a first dielectric material, said first dielectric material surrounding a plurality of discrete dielectric regions included within said photonic coupling device, said discrete dielectric regions having a dielectric constant that differs from the dielectric constant of said first dielectric material, said discrete dielectric regions having two or more sizes, wherein said discrete dielectric regions are arranged in order of increasing or decreasing size in a direction extending between said input end and said output end.

2. The optical element of claim 1, wherein said the dielectric constant of said discrete dielectric regions is less than the dielectric constant of said first dielectric material.

3. The optical element of claim 1, wherein said discrete dielectric regions are holes.

4. The optical element of claim 1, wherein said discrete dielectric regions have a circular cross-section.

5. The optical element of claim 1, wherein the centers of said discrete dielectric regions are collinear.

6. The optical element of claim 5, wherein said collinear discrete dielectric regions are aligned along the central axis extending between said input end and said output end of said coupling device.

7. The optical element of claim 1, wherein said discrete dielectric regions have three or more sizes.

8. The optical element of claim 1, wherein said discrete dielectric regions have five or more sizes.

9. The optical element of claim 1, wherein said discrete dielectric regions are all formed from the same material.

10. The optical element of claim 1, wherein the characteristic impedance for the propagation of an optical signal through said photonic coupling device is approximately constant between said input end and said output end.

11. The optical element of claim 1, wherein said photonic coupling device further includes a photonic groove, said photonic groove having a width less than the width of said photonic coupling device and extending for a distance less than the length of said photonic coupling device, said photonic groove having a central axis extending in its length direction, said photonic groove corresponding to a continuous dielectric region having a dielectric constant that differs from the dielectric constant of said first dielectric material.

12. The optical element of claim 11, wherein the centers of said discrete dielectric regions are collinear with said central axis of said photonic groove.

13. The optical element of claim 11, wherein an end of said photonic groove overlaps said input end or said output end of said photonic coupling device.

14. The optical element of claim 11, wherein the dielectric of said photonic groove is less than the dielectric constant of said first dielectric material

15. The optical element of claim 11, wherein the dielectric of said photonic groove is the same as the dielectric constant of one of said discrete dielectric regions

16. An optical circuit comprising:
the photonic coupling device of claim 1; and
a first optical element interconnected to said input or output end of said coupling device,
wherein said optical circuit transfers an optical signal from said photonic coupling device to said first optical element or from said first optical element to said photonic coupling device.

17. The optical circuit of claim 16, wherein said first optical element is an optical fiber or a waveguide.

18. The optical circuit of claim 16, wherein said first optical element is a photonic crystal, said photonic crystal comprising a plurality of dielectric objects periodically arranged within a second dielectric material.

19. The optical circuit of claim 18, wherein said photonic crystal includes a defect.

20. The optical circuit of claim 19, wherein said optical circuit transfers an optical signal from said photonic coupling device to said defect of said photonic crystal.

21. The optical circuit of claim 19, wherein said optical circuit transfers an optical signal from said defect of said photonic crystal to said photonic coupling device.

22. The optical circuit of claim 19, wherein said defect is a linear defect.

23. The optical circuit of claim 22, wherein said linear defect forms a waveguide channel.

24. The optical circuit of claim 18, wherein said periodically arranged dielectric objects are holes.

25. The optical circuit of claim 24, wherein said photonic crystal includes a linear defect, said linear defect comprising defect holes having a uniform size, said uniform size of said defect holes differing from the size of said periodically arranged holes.

26. The optical circuit of claim 25, wherein said defect holes are larger than said periodically arranged holes.

27. The optical circuit of claim 25, wherein said periodically arranged holes or said defect holes are filled with a solid or liquid material.

28. The optical circuit of claim 24, wherein said discrete dielectric regions of said photonic coupling device are holes, the centers of said holes of said photonic coupling device being collinear with the centers of said defect holes of said linear defect of said photonic crystal.

29. The optical circuit of claim 28, wherein said photonic coupling device further includes a photonic groove, said photonic groove having a width less than the width of said photonic coupling device and extending for a distance less than the length of said photonic coupling device, said photonic groove corresponding to a continuous dielectric region having a dielectric constant that differs from the dielectric constant of said first dielectric material of said photonic coupling device, said photonic groove having a central axis, said central axis being collinear with the centers of said holes of said photonic coupling device.

30. The optical circuit of claim 29, wherein the dielectric constant of said photonic groove is less than the dielectric constant of said first dielectric material.

31. The optical circuit of claim 16, wherein said photonic coupling device is partially embedded within said first optical element.

32. The optical circuit of claim 16, further comprising a second optical element interconnected to the end of said photonic coupling device to which said first optical element is not interconnected

33. An optical circuit comprising
a photonic coupling device having an input end and an output end, said photonic coupling device comprising a first dielectric material and a photonic groove, said photonic groove having a width less than the width of said photonic coupling device, said photonic groove corresponding to a continuous dielectric region having a dielectric constant that differs from the dielectric constant of said first dielectric material of said photonic coupling device; and
a first optical element interconnected to said input end or said output end of said photonic coupling device.

34. The optical circuit of claim 33, wherein an end of said photonic groove overlaps said input end or said output end of said photonic coupling device.

35. The optical circuit of claim 33, wherein said photonic groove has a tapered end.
